(19) United States
(12) Patent Application Publication
(10) Pub. No.: US 2023/0319811 A1
(43) Pub. Date: Oct. 5, 2023

(54) ROBUST ULTRA-WIDEBAND SYSTEM AND METHOD FOR IN-VEHICLE SENSING

(71) Applicant: Robert Bosch GmbH, Stuttgart (DE)

(72) Inventors: Vivek Jain, Sunnyvale, CA (US); Yunze Zeng, San Jose, CA (US)

(21) Appl. No.: 17/710,666

(22) Filed: Mar. 31, 2022

(51) Int. Cl. H04W 72/12; H04B 1/69; G01S 13/00; G01S 13/02

(52) U.S. Cl. CPC H04W 72/1215; H04B 1/69; G01S 13/003; G01S 13/0209

(57) ABSTRACT

A method relates to managing communications among a set of system nodes. The set of system nodes is configured to sense a predetermined region. The method includes establishing, via a processor, a schedule that includes a communication timeslot and a sensing timeslot, which are non-overlapping. A first system node or a second system node is operable to transmit a first message wirelessly during the communication timeslot. The second system node is operable to transmit a radar transmission signal during the sensing timeslot. The second system node is operable to receive a radar reflection signal during the sensing timeslot. The radar reflection signal is based on the radar transmission signal. The first system node or the second system node is operable to transmit a second message wirelessly during the sensing timeslot. The method includes determining channel state data of the second message via a subset of the set of system nodes during the sensing timeslot. The processor is operable to generate sensor fusion data based on the radar reflection signal and the channel state data. The processor is operable to determine a sensing state of the predetermined region based on the sensor fusion data.

### FIELD

This disclosure relates generally to ultra-wideband based (UWB) systems and methods with radar for in-vehicle sensing.

### BACKGROUND

In general, there are a number of initiatives underway to address issues relating to heatstroke deaths of children that occur when they are left behind in vehicles. For example, the European New Car Assessment Programme (EuroNCAP) plans on providing safety rating points for technical solutions that address issues relating to children being left behind in vehicles. In addition, safety rating points may be given for driver/occupant monitoring and rear seat belt reminder applications. However, there are a number of challenges with respect to providing technical solutions with sensors that address these issues while providing reliable sensing coverage for the entire vehicle without significantly increasing overall costs.

### SUMMARY

The following is a summary of certain embodiments described in detail below. The described aspects are presented merely to provide the reader with a brief summary of these certain embodiments and the description of these aspects is not intended to limit the scope of this disclosure. Indeed, this disclosure may encompass a variety of aspects that may not be explicitly set forth below.

According to at least one aspect, a method relates to managing communications among a set of system nodes. The set of system nodes is configured to sense a predetermined region. The method includes establishing, via a processor, a schedule that includes a communication timeslot and a sensing timeslot, which are non-overlapping. A first system node or a second system node is operable to transmit a first message wirelessly during the communication timeslot. The second system node is operable to transmit a radar transmission signal during the sensing timeslot. The second system node is operable to receive a radar reflection signal during the sensing timeslot. The radar reflection signal is based on the radar transmission signal. The first system node or the second system node is operable to transmit a second message wirelessly during the sensing timeslot. The method includes determining channel state data of the second message via a subset of the set of system nodes during the sensing timeslot. The processor is operable to generate sensor fusion data based on the radar reflection signal and the channel state data. The processor is operable to determine a sensing state of the predetermined region based on the sensor fusion data.

According to at least one aspect, a method relates to managing communications among a set of system nodes. The set of system nodes is configured to sense a predetermined region. The method includes establishing a schedule that includes a first localization timeslot, a second localization timeslot, and a sensing timeslot. The sensing timeslot occurs between the first localization timeslot and the second localization timeslot. The method includes transmitting a first set of messages wirelessly from a first system node to a target device so that the target device is localized during the first localization timeslot. The method includes transmitting a second set of messages wirelessly from the first system node to the target device so that the target device is localized during the second localization timeslot. The method includes transmitting a radar transmission signal from the first system node during the sensing timeslot. The method includes receiving, via the first system node, a radar reflection signal during the sensing timeslot. The radar reflection signal is based on the radar transmission signal. The method includes transmitting another message wirelessly from the first system node or the second system node during the sensing timeslot. The method includes determining channel state data of the another message via a subset of the set of system nodes during the sensing timeslot. The method includes generating sensor fusion data based on the radar reflection signal. The method includes determining a sensing state of the predetermined region using the sensor fusion data.

These and other features, aspects, and advantages of the present invention are discussed in the following detailed description in accordance with the accompanying drawings throughout which like characters represent similar or like parts.

### BRIEF DESCRIPTION OF THE DRAWINGS

FIG. 1A is a diagram of an example of a system with an UWB infrastructure for in-vehicle sensing and vehicle access control according to an example embodiment of this disclosure.

FIG. 1B is a diagram of an example of a communication system node according to an example embodiment of this disclosure.

FIG. 1C is a diagram of an example of a dual-mode system node according to an example embodiment of this disclosure.

FIG. 1D is a diagram of an example of a target device according to an example embodiment of this disclosure.

FIG. 2A is a diagram of an example of a set of system nodes that include dual-mode system nodes with respect to a vehicle according to an example embodiment of this disclosure.

FIG. 2B is a diagram of an example of another set of system nodes that include dual-mode system nodes with respect to a vehicle according to an example embodiment of this disclosure.

FIG. 3 is a diagram of a first example of a pipeline of the system of FIG. 1 according to an example embodiment of this disclosure.

FIG. 4 is a diagram of an example of signal processing associated with the pipeline of FIG. 3 according to an example embodiment of this disclosure.

FIG. 5 is a diagram of a second example of a pipeline of the system of FIG. 1 according to an example embodiment of this disclosure.

FIG. 6A is a diagram of an example of the set of system nodes of FIG. 2A that further include at least one pair of communication system nodes on an exterior portion of a vehicle according to an example embodiment of this disclosure.

FIG. 6B is a diagram of an example of the set of system nodes of FIG. 2B that further include at least one pair of dual-mode system nodes on an exterior portion of a vehicle according to an example embodiment of this disclosure.

FIG. 7A is an example of a portion of a timing diagram that illustrates how the system of FIG. 1 controls and manages UWB localization and UWB sensing according to an example embodiment of this disclosure.

FIG. 7B illustrates a first example of the UWB sensing timeslot according to an example embodiment of this disclosure.

FIG. 7C illustrates a second example of the UWB sensing timeslot according to an example embodiment of this disclosure.

FIG. 8A is a diagram that illustrates a set of system nodes that include at least one communication system node, at least one dual-mode system node, and at least one high-frequency radar device with respect to a vehicle according to an example embodiment of this disclosure.

FIG. 8B is a diagram that illustrates another set of system nodes that include at least one communication system node, at least one dual-mode system node, and at least one high-frequency radar device with respect to a vehicle according to an example embodiment of this disclosure.

FIG. 9 is an example of a portion of a timing diagram that illustrates how the system of FIG. 1 controls and manages UWB localization and UWB sensing with respect to high-frequency radar sensing according to an example embodiment of this disclosure.

FIG. 10A is a diagram that illustrates a set of system nodes that include at least one communication system node, at least one dual-mode system node, at least one high-frequency radar device, at least one microphone, and at least one camera with respect to a vehicle according to an example embodiment of this disclosure.

FIG. 10B is a diagram that illustrates another set of system nodes that include at least one communication system node, at least one dual-mode system node, at least one high-frequency radar device, at least one microphone, and at least one camera with respect to a vehicle according to an example embodiment of this disclosure.

FIG. 11 is a diagram a third example of a pipeline of the system of FIG. 1 according to an example embodiment of this disclosure.

FIG. 12 is a diagram of a fourth example of a pipeline of the system of FIG. 1 according to an example embodiment of this disclosure.

### DETAILED DESCRIPTION

The embodiments described herein, which have been shown and described by way of example, and many of their advantages will be understood by the foregoing description, and it will be apparent that various changes can be made in the form, construction, and arrangement of the components without departing from the disclosed subject matter or without sacrificing one or more of its advantages. Indeed, the described forms of these embodiments are merely explanatory. These embodiments are susceptible to various modifications and alternative forms, and the following claims are intended to encompass and include such changes and not be limited to the particular forms disclosed, but rather to cover all modifications, equivalents, and alternatives falling with the spirit and scope of this disclosure.

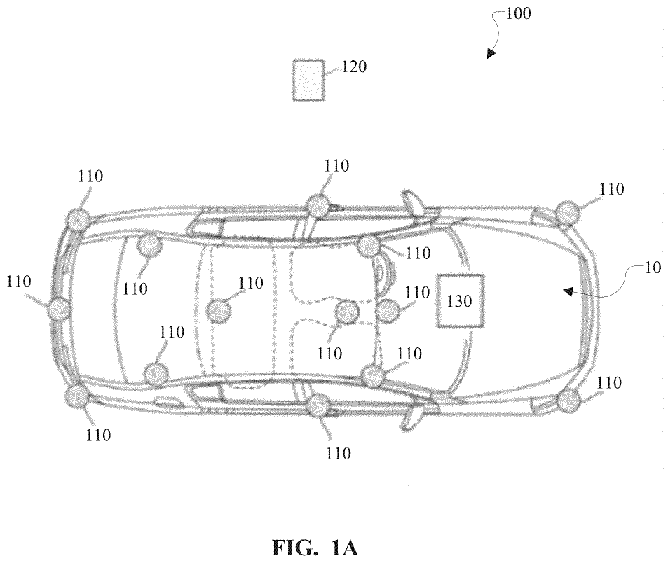

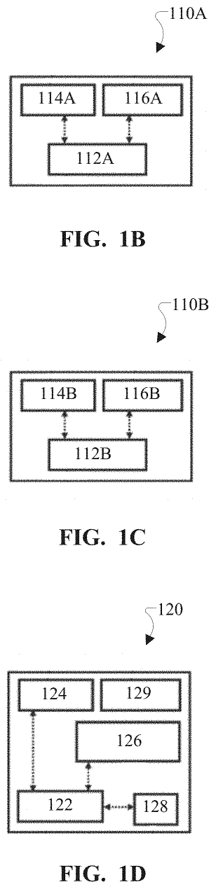

FIG. 1A is a diagram of an example of a system 100 with an UWB infrastructure that provides a vehicle access system and also in-vehicle sensing according to an example embodiment. More specifically, the system 100 includes a plurality of system nodes 110 arranged at various locations of the vehicle 10. It is appreciated that the particular number of system nodes 110 and particular locations of the system nodes 110 depends on the desired accuracy and performance, as well as the particular make and model of the vehicle 10. The system nodes 110 are configured to communicate with a target device 120, which is portable, to determine a position of the target device 120. In an example embodiment, the system 100 may be configured such that a particular system node is designated as a master system node and other system nodes are designated as slave system nodes such that master system node controls communications with the slave system nodes and collects data from the slave system nodes S for the purpose of localizing the target device 120. Processing of the data collected from the system nodes 110 to localize the target device 120 is performed by the master system node or the processing system 130. In an example embodiment, the processing system 130 includes an electronic control unit (ECU). In at least one embodiment, UWB communications are utilized between the system nodes 110 and the target device 120 to enable localization thereof. Each system node 110 is a communication system node 110A or a dual-mode system node 110B.

FIG. 1B shows an example of a communication system node 110A according to an example embodiment. In the illustrated embodiment, each communication system node 110A comprises a processor 112A, memory 114A, and a transceiver 116A. The memory 114A is configured to store program instructions that, when executed by the processor 112A, enable the respective communication system node 110A to perform various operations described elsewhere herein, including localization of the target device 120 and sensing of a predetermined region. The memory 114A may be of any type of device capable of storing information accessible by the processor 112A, such as write-capable memories, read-only memories, or other non-transitory computer-readable mediums. Additionally, the processor 112A includes any hardware system, hardware mechanism or hardware component that processes data, signals, or other information. The processor 112A may include a system with a central processing unit, multiple processing units, dedicated circuitry for achieving functionality, or other systems. In an example, the communication system node 110A includes a microcontroller, which contains at least the processor 112A and the memory 114A along with programmable input/output peripherals.

The transceiver 116A includes at least UWB transceiver configured to communicate with the target device 120 and may include any of various other devices configured for communication with other electronic devices, including the ability to send communication signals and receive communication signals. In some embodiments, the transceiver 116A comprises multiple UWB transceivers and/or multiple UWB antennas arranged in an array. In an example embodiment, the transceiver 116A includes at least one further transceiver configured to communicate with the other system nodes 110 (e.g., communication system nodes 110A, dual-mode nodes 110B, etc.), the target device 120, and/or the processing system 130, via a wired or wireless connection.

FIG. 1C shows an example of a dual-mode system node 110B according to an example embodiment. The dual-mode system node 110B is configured to switch between a UWB communication mode and a UWB radar mode. More specifically, in the illustrated embodiment, the dual-mode system node 110B comprises at least a processor 112B, a memory 114B, and a transceiver 116B. The processor 112B includes any hardware system, hardware mechanism or hardware component that processes data, signals, or other information. The processor 112B may include a system with a central processing unit, multiple processing units, dedicated circuitry for achieving functionality, a digital signal processor (DSP), or other processing technology. The memory 114B is configured to store program instructions that, when executed by the processor 112B, enable the respective system node 110 to perform various operations described elsewhere herein, including localization of the target device 120, sensing of a sensing region, switching between communication mode and radar mode, performing signal processing, etc. The memory 114B may be of any type of device capable of storing information accessible by the processor 112B, such as write-capable memories, read-only memories, or other non-transitory computer-readable mediums. In an example, the dual-mode system node 110B includes a microcontroller, which contains at least the processor 112B and the memory 114B along with programmable input/output peripherals.

The transceiver 116B includes at least a transceiver, which is configured switch between transmitting/receiving UWB communication and transmitting/receiving UWB radar, respectively. The transceiver 116B is configured to communicate with the target device 120 and may include any of various other devices configured for communication with other electronic devices, including the ability to send communication signals and receive communication signals. In some embodiments, the transceiver 116B comprises multiple UWB transceivers and/or multiple UWB antennas arranged in an array. The multiple UWB transceivers and/or multiple UWB antennas are configured to transmit/receive UWB communications and UWB radar, respectively. In an example embodiment, the transceiver 116B includes at least one further transceiver configured to communicate with the other system nodes 110 (e.g., communication system nodes 110A, dual-mode system nodes 110B, etc.), the target device 120, and/or the processing system 130, via a wired or wireless connection.

The dual-mode system node 110B is operable to switch between communication mode and radar mode, respectively. Also, the dual-mode system node 110B is operable to transmit pulses in radar mode and communication mode, respectively. The duration of those pulses and/or number of those transmitted pulses differs in these two distinct modes. For example, one or more pulses generated in the radar mode differ from one or more pulses generated in communication mode with respect to pulse shape, repetition frequency, pulse power, number of pulses, duration of pulse transmission, any appropriate pulse feature, or any number and combination thereof.

In an example embodiment, for instance, the dual-mode system node 110B includes one or more switching mechanisms, implemented via hardware, software, or a combination thereof, which is configured to provide the communication mode and the radar mode, respectively, and enable the dual-mode system node 110B to switch between these two modes. As a non-limiting example, for instance, the dual-mode system node 110B may include a switch connected to an antenna and a radio integrated circuit (IC), which may be present in FIG. 1C but not shown in this high-level block diagram. This switch controls whether an antenna is connected to at least one transmitting or receiving circuit. Further, this switch controls whether the antenna is connected to radar receiving circuit or communication mode receiving circuit. Further, in the case that there are multiple antennas in the dual-mode system node 110B, then the dual-mode system node 110B may include a switch per antenna to control its operation (e.g., transmitting or receiving) or a switch to choose an antenna and a switch to enable operation (e.g., transmitting or receiving radar or receiving communication).

As discussed above, the dual-mode system node 110B is advantageously configured to selectively switch between radar mode and communication mode. More specifically, the dual-mode system node 110B is configured to operate in communication mode or radar mode. For example, when in communication mode, each dual-mode system node 110B is enabled to contribute to in-vehicle sensing throughout the vehicle 10 via UWB communication. Also, when in radar mode, each dual-mode system node 110B is operable to provide targeted sensing for specific locations (e.g. seats). In addition, the use of UWB radar contributes to providing health status data (e.g., heart rates, breathing rates) of at least one living being in the vehicle 10.

FIG. 1D shows a non-limiting example of the target device 120, which may comprise a key-fob, a smart phone, a smart watch, or any suitable electronic device. In the illustrated embodiment, the target device 120 comprises at least a processor 122, memory 124, transceivers 126, an I/O interface 128, and a battery 129. The memory 124 is configured to store program instructions that, when executed by the processor 122, enable the target device 120 to perform various operations described elsewhere herein, including communicating with the system nodes 110 for the purpose of localizing the target device 120. The memory 124 may be of any type of device capable of storing information accessible by the processor 122, such as a memory card, ROM, RAM, hard drives, discs, flash memory, or other non-transitory computer-readable mediums. Additionally, the processor 122 includes any hardware system, hardware mechanism or hardware component that processes data, signals or other information. The processor 122 may include a system with a central processing unit, multiple processing units, dedicated circuitry for achieving functionality, or other systems.

The transceivers 126 includes at least an UWB transceiver configured to communicate with the system nodes 110 (e.g., communication system nodes 110A, dual-mode nodes 110B, etc.) and may also include any of various other devices configured for communication with other electronic devices, including the ability to send communication signals and receive communication signals. In an example embodiment, the transceivers 126 further include additional transceivers which are common to smart phones and/or smart watches, such as Wi-Fi or Bluetooth® transceivers and transceivers configured to communicate via for wireless telephony networks. The I/O interface 128 includes software and hardware configured to facilitate communications with the one or more interfaces (not shown) of the target device 120, such as tactile buttons, switches, and/or toggles, touch screen displays, microphones, speakers, and connection ports. The battery 129 is configured to power the various electronic devices of the target device 120 and may comprise a replaceable or rechargeable battery.

In an example embodiment, the processing system 130 is configured to control and monitor various electronic functions relating to the vehicle 10. In this regard, for example, the processing system 130 includes at least one electronic control unit (ECU). In an example, the processing system 130 includes a microcontroller. In an example, the processing system comprises at least a processor, a memory, and an I/O interface. The memory is configured to store program instructions that, when executed by the processor, enable the processing system 130 to perform various operations described elsewhere herein, including localization of the target device 120, sensing one or more sensing regions. The memory may be of any type of device capable of storing information accessible by the processor, such as a memory card, ROM, RAM, hard drives, discs, flash memory, or other computer-readable medium. Additionally, the processor includes any hardware system, hardware mechanism or hardware component that processes data, signals or other information. The processor may include a system with a central processing unit, multiple processing units, dedicated circuitry for achieving functionality, or other systems. The I/O interface includes software and hardware configured to facilitate monitoring and control of various electronics and their functions.

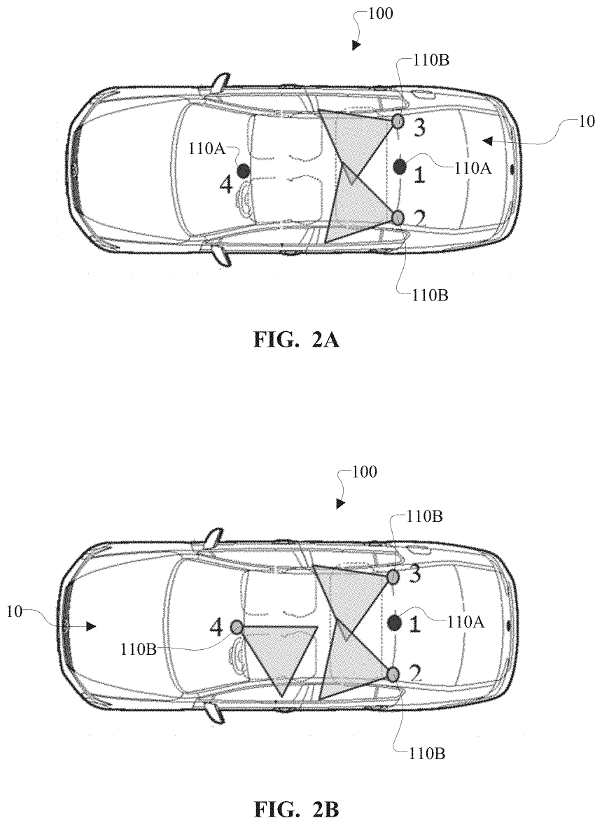

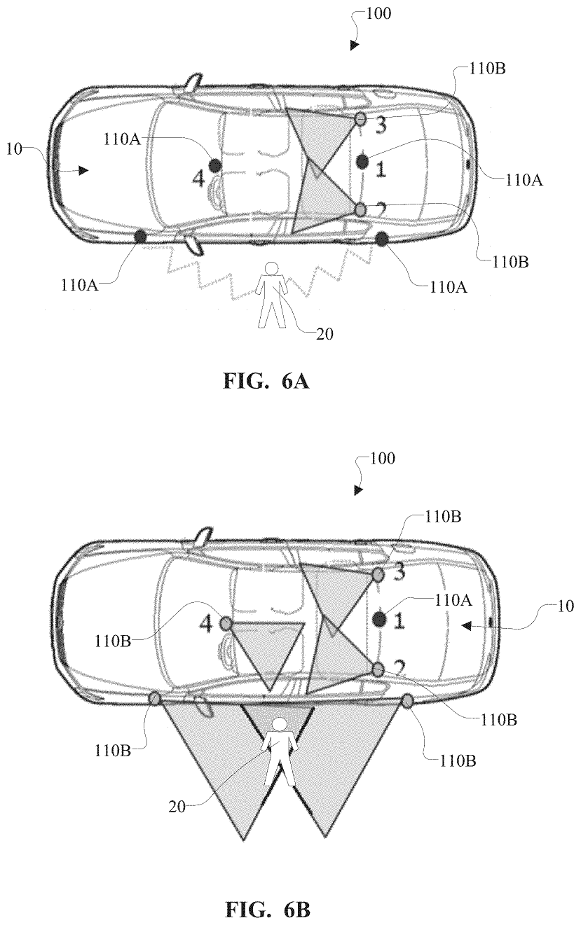

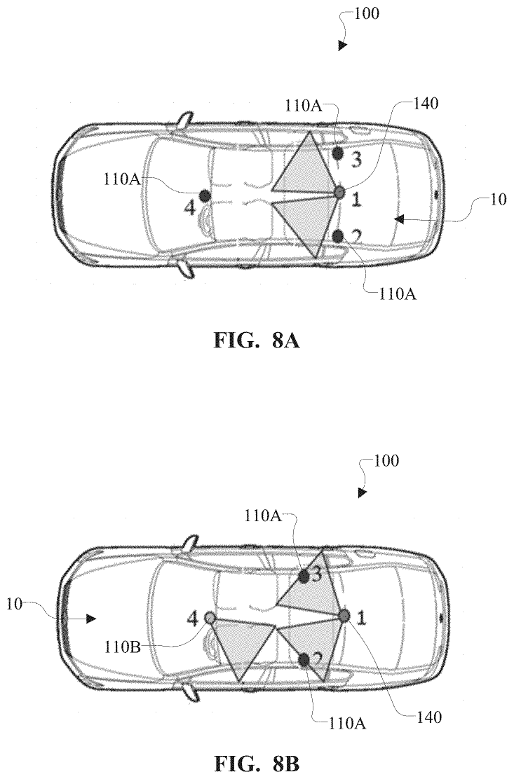

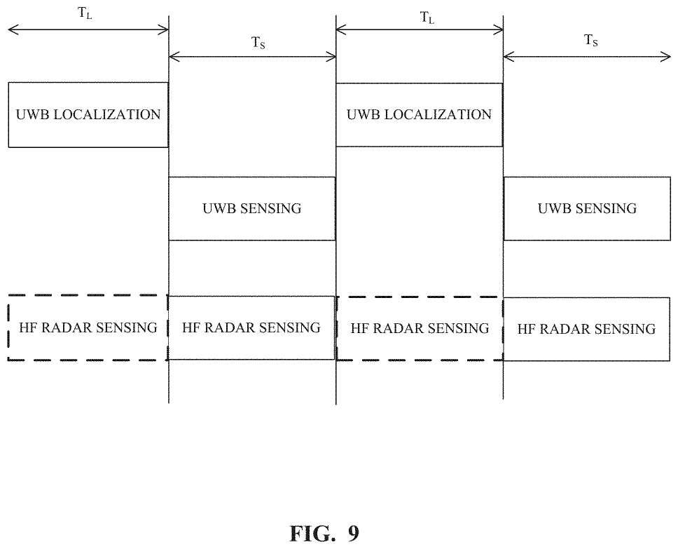

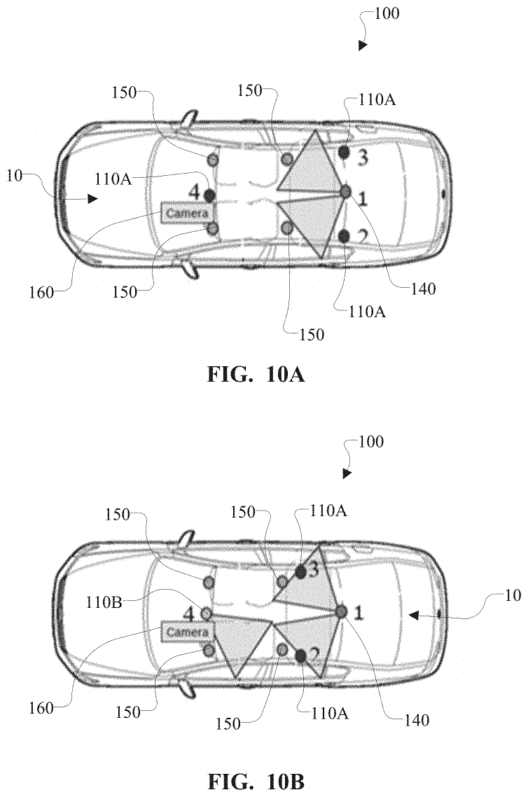

FIG. 2A and FIG. 2B illustrate non-limiting examples of sets of system nodes with respect to the vehicle 10 according to an example embodiment. FIG. 2A and FIG. 2B illustrate examples with at least one communication system node 110A and at least one dual-mode system node 110B. In this regard, FIG. 2A and FIG. 2B illustrate non-limiting examples of node arrangements with respect to the vehicle 10. In addition, FIG. 2A and FIG. 2B include non-limiting conceptual representations of the sensing regions of the dual-mode system nodes 110B in the form of shaded triangles, which are also used in FIG. 6A, FIG. 6B, FIG. 8B, and FIG. 10B. The embodiments are not limited to these node arrangements, as there are a number of other node arrangements. FIG. 2A and FIG. 2B also illustrate examples of node arrangements in which UWB radar and UWB communications are combinable to provide sensing state data and/or sensing applications.

FIG. 2A illustrates a first arrangement that includes a UWB communication system node 110A at the first location, a UWB dual-mode system node 110B at the second location, a UWB dual-mode system node 110B at the third location, and a UWB communication system node 110A at the fourth location. FIG. 2B illustrates a second arrangement that includes a UWB communication system node 110A at the first location, a UWB dual-mode system node 110B at the second location, a UWB dual-mode system node 110B at the third location, and a UWB dual-mode system node 110A at the fourth location. In this regard, the second node arrangement of FIG. 2B differs with respect to the first node arrangement of FIG. 2A in that the fourth location in FIG. 2B includes a dual-mode system node 110B whereas the fourth location in FIG. 2A includes a communication system node 110A. In this regard, the first node arrangement of FIG. 2A is operable to provide backseat sensing with the dual-mode system nodes 110B at the second location and the third location. Meanwhile, the second node arrangement of FIG. 2B is operable to provide driver seat sensing with the dual-mode system node 110B at the fourth location and backseat sensing with the dual-mode system nodes 110B at the second location and the third location. In this regard, FIG. 2A and FIG. 2B show examples of how the dual-mode system nodes 110B and the communication system nodes 110A may be strategically used together to generate sensor fusion data, thereby enabling various sensing state data to be generated to benefit various in-vehicle sensing applications.

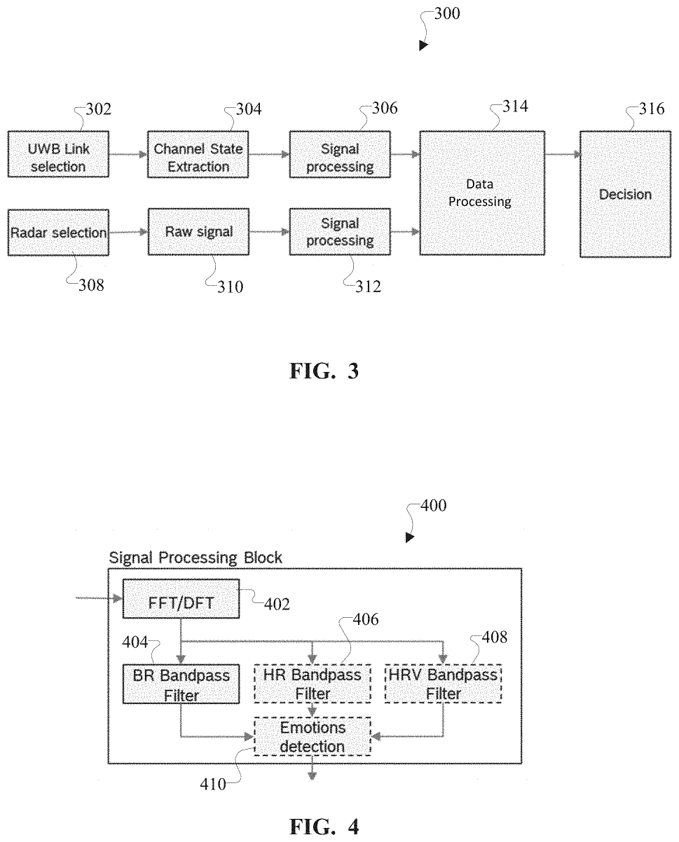

FIG. 3 illustrates a pipeline 300 with several phases, which include a number of operations that are performed by the system 100 using the UWB infrastructure. The pipeline 300 is not limited to the phases shown in FIG. 3. In this regard, the pipeline 300 may include more phases or less phases than that shown in FIG. 3 provided that the system 100 is operable to perform the functions as described herein. As a general overview, the pipeline 300 is provided with phases in which the UWB communication signals and the UWB radar signals undergo signal processing operations separately before being fed to phase 314, where they are processed together and combined to generate sensor-fusion data such that one or more sensing states can be determined.

At phase 302, according to an example, the system 100 is operable to perform an automatic selection (or receive a manual selection) of a UWB system node 110 from among the set of UWB system node 110s to operate as a transmitter. The UWB link selection (i.e., system node 110 selection) at phase 302 may be determined based on a number of factors (e.g., calibration process, connectivity strength, communication rate, location of a system node 110, etc.). In response to UWB link selection, the selected system node 110 is operable to transmit one or more messages while the remaining UWB system nodes 110 (or the unselected system nodes 110) are operable to receive those one or more messages from the selected system node 110. In addition, the system 100 is configured to select one or more features that contribute to the prediction output (e.g., per-seat occupancy prediction). These features may include, for instance, channel impulse response (CIR) data, amplitude, peaks/valleys, distances between peaks/valleys, number of peaks/valleys, any suitable CIR data, or any number and combination thereof.

At phase 304, according to an example, the system 100 captures the CIR data from each of the UWBs system node 110, in accordance with the selected features. For instance, when receiving, each UWB system node 110 may collect CIRs, and may send the decoded CIR measurements to the processing system 130.

At phase 306, according to an example, the system 100 applies at least one signal processing algorithm to increase the resolution of each radio frequency (RF) signal received or each UWB communication signal. For instance, the system 100 may increase the resolution of a computed CIR by interpolating and upsampling in the frequency domain to aid in accurate alignment and feature extraction. Additionally or alternatively, the system 100 is operable to perform peak detection and alignment, scaling, metadata processing, or any number and combination thereof. The system 100 is operable to perform signal processing operations in relation to metadata, e.g., peak power, average power, first peak power to second peak power ratios, width of first peak, time difference between first and second peaks, etc. as derived from CIR. After performing communication signal processing on the RF signal (e.g., UWB communication signal), the system 100 outputs and provides communication signal data to phase 314.

At phase 308, according to an example, the system 100 is configured to select at least one dual-mode system node 110B for transmitting a radar transmission signal. The system 100 is configured to automatically select the dual-mode system node 110B. The system 100 is configured to permit a manual selection of the dual-mode system node 110B. The dual-mode system node 110B may be selected based on a number of factors (e.g., location of a node, operating state of the node, etc.). Upon being selected, the dual-mode system node 110B operates in radar mode to transmit a radar transmission signal.

At phase 310, according to an example, the system 100 is configured to obtain a radar reflection signal that is based on the radar transmission signal. More specifically, the node, which transmits the radar transmission signal, is operable to receive the radar reflection signal. The system 100 is operable to receive the radar reflection signal in raw form. The radar reflection signal is provided to a signal processor and/or applied with at least one signal processing algorithm at phase 312.

At phase 312, according to an example, the system 100 is configured to apply at least one radar signal processing algorithm to the raw radar reflection signal, which was received at phase 310. The system 100 is configured to perform this signal processing via the processor of the dual-mode system node 110B, the ECU, or via any combination thereof. At this phase, the system 100 is configured to improve a quality of the raw form of the radar reflection signal. In this regard, the system 100 is also configured to detect components of interest in the radar reflection signal. For example, the radar signal processing includes a denoising process, a Fast Fourier Transform (FFT) process, a Discrete Fourier Transform (DFT) process, a band pass filtering process, or any number and combination thereof. After performing radar signal processing on the radar reflection signal, the system 100 outputs and provides radar signal data to phase 314.

At phase 314, according to an example, the system 100 is operable to receive the communication signal data from phase 306 and the radar signal data from phase 312. The system 100 is operable to perform data processing on the communication signal data and the radar signal data via the processing system 130 (e.g., the ECU). In an example embodiment, for example, the system 100 is operable to combine the communication signal data and the radar signal data. More specifically, the system 100 is operable to generate sensor fusion data based on the communication signal data from phase 306 and the radar signal data from phase 312.

Additionally or alternatively, the system 100 is operable to use different thresholds to detect activity/presence within the vehicle 10. The system 100 is operable to determine and evaluate a relative variation of parameters to determine activity/presence. For example, the ratio of peak power to average power will be higher when a direct path is not blocked and at the same time peak power is also the first peak in CIR. When that path is blocked by any object, then the ratio will be reduced with a higher possibility of a subsequent peak with a higher power than the first peak. Accordingly, this resulting data may then be used by the system 100 to determine activity/presence.

Also, in an example, the system 100 is configured to perform at least one machine learning algorithm via at least one machine learning system. The machine learning system includes an artificial neural network (e.g., a convolutional neural network), a support vector machine, a decision tree, any suitable machine learning model, or any number and combination thereof. In an example, the machine learning system is operable to perform one or more classification tasks on the sensor fusion data so that a sensing state of the predetermined region (e.g., interior of a vehicle 10) is determinable. In this regard, for instance, the machine learning system is configured to perform object detection and recognition based on the sensor fusion data of the predetermined region (e.g., interior of a vehicle 10).

At phase 316, according to an example, the system 100 is operable to determine a given sensing state of the predetermined region (e.g., interior of a vehicle 10). The system 100 is configured to determine a given sensing state based at least on the sensor fusion data, the machine learning output data, or any number and combination thereof. As a non-limiting example, the sensing state data may include occupancy data, animate object data, inanimate object data, activity data, biometric data, emotion data, any suitable sensing data, or any number and combination thereof. For instance, the sensing state data may indicate if there is any occupancy or no occupancy in the vehicle 10. If there is occupancy, then sensing state data may indicate which area (or seat) is occupied or vacant. If there is occupancy, then the sensing state data may indicate if that occupancy includes an animate object, an inanimate object, or any number and combination thereof. If there is at least one animate object, then the sensing state data may indicate if each detected animate object is an animal, a human, an adult, a child, or any suitable living label. If there is at least one animate object, then the sensing state data may provide biometric data (e.g., breathing rate, heart rate, etc.), health/wellness monitoring data, emotions data, or any number and combination thereof. As a non-limiting example, with respect to the emotions data, the sensing state data may determine if a fight is going to happen. If there is at least one inanimate object, then the sensing state data may include object classification data. As discussed above, the system 100 is advantageous in being operable to provide sensing state data of the predetermined region (e.g., interior of a vehicle 10) at any given instance in real-time.

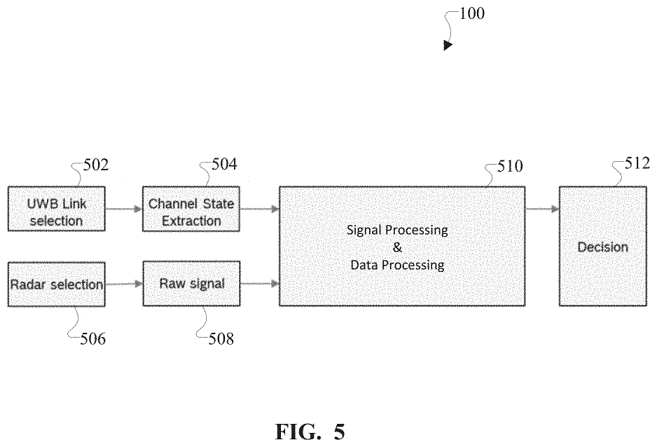

FIG. 4 illustrates a block diagram 400 of the signal processing of FIG. 3 in an example sensing application relating to detecting and monitoring vital signs. This block diagram 400 illustrates a number of signal processing operations that may be performed at phase 306, phase 312, or both phases 306 and 312. For example, when applied as the signal processing at phase 306, the system 100 includes one or more link selections, which provide the CIR data that may be used to determine vital signs of at least one living being within the predetermined region (e.g., interior of the vehicle 10). The signal processing includes various algorithms for determining breathing rate and heart rate based on the CIR data received. For instance, FIG. 4 illustrates various algorithms that may be employed by signal processing. As shown, the signal processing may involve processing the CIR data using an FFT and/or a DFT process 402. In this example, the signal processing includes applying a breathing rate (BR) bandpass filter 404, a heart rate (HR) band pass filter 406, a heart rate variability (HRV) bandpass filter 408, or any suitable number and combination thereof. An emotion detection algorithm 410 may receive and further process the output data from the BR bandpass filter 404, the HR bandpass filter 406, the HRV bandpass filter 408, or any number and combination thereof.

FIG. 5 illustrates a pipeline 500 with several phases, which include a number of operations that are performed by the system 100 using the UWB infrastructure according to an example embodiment. The pipeline 500 (FIG. 5) includes a number of phases that are the same as or similar to the phases of the pipeline 300 (FIG. 3). As descriptions of these similar phases may be referenced with respect to FIG. 3, they are not repeated below. In this regard, for example, phase 502 is similar to or the same as phase 302, phase 504 is similar to or the same as phase 304, phase 506 is similar to or the same as phase 308, phase 508 is similar to or the same as phase 310, and phase 512 is similar to or the same as phase 316. However, unlike the pipeline 300 (FIG. 3), which processes the communication signal and the radar signal separately before proceeding to phase 314, the pipeline 500 (FIG. 5) feeds the raw radar reflection signal and the raw communication signal with channel state data to phase 510, which combines the signal processing operations and the data processing operations. In the pipeline 500, the processing system 130 is operable to perform both the signal processing operations and the data processing operations at phase 510, thereby offloading this signal processing burden from each selected system node 110. In contrast, the pipeline 300 has each selected system node 110 perform its own signal processing operations with its processor 112A/112B before proceeding to phase 314 for data processing by the processing system 130.

FIG. 6A and FIG. 6B illustrate examples of the vehicle 10 in which a pair of system nodes 110 are disposed on an external portion of the vehicle 10 according to an example embodiment. More specifically, in this case, FIG. 6A and FIG. 6B illustrate the pair of system nodes 110 on the driver side of the vehicle 10. In this regard, a similar pair of system nodes 110 or a single node (e.g., HF radar device 140) may be applied to other external portions of the vehicle 10 that are at other locations, such as a passenger side, a trunk side, or any suitable location to enable keyless applications on that external side of the vehicle 10. FIG. 6A and FIG. 6B relate to keyless applications. Once a valid user 20 with a valid target device 120 (e.g., key or smartphone) is detected within a predetermined range or a sensing range of the vehicle 10, then these pair of system nodes 110 are turned ‘on’ to support operations relating to vehicle access and/or keyless applications. In this regard, the external pairs of system nodes 110, as shown in FIG. 6A and FIG. 6B, are advantageous in preventing energy wastage for continuous sensing while reducing false positives. In addition, each external pair of system nodes 110 may contribute to enhanced user experience. In this regard, for example, an external pair of system nodes 110 may be used to detect a walking pattern of a user 20 for an additional level of security, macro gestures (e.g., hand movements, foot movements, etc.) for door and light operations, etc.

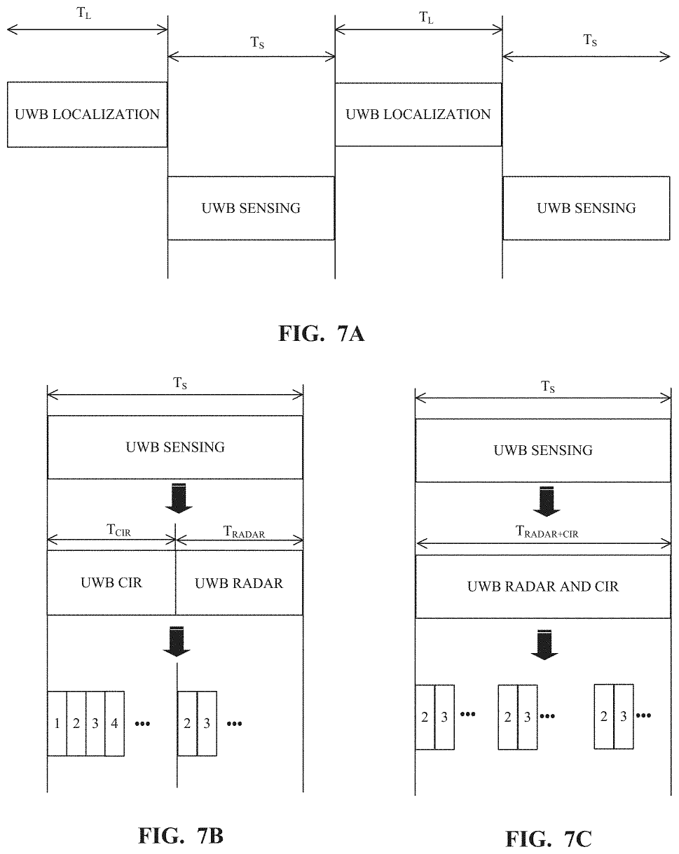

FIG. 7A is a timing diagram, which illustrates how the system 100 controls and manages UWB localization and UWB sensing with the same UWB infrastructure according to an example embodiment. More specifically, in the example shown in FIG. 7A, the system 100 is configured to allocate predetermined timeslots for UWB localization and UWB sensing, respectively. The system 100 (e.g. the processing system 130) is operable to establish or generate a schedule that includes a UWB localization timeslot (T_{L}) and a UWB sensing timeslot (T_{S}). As shown in FIG. 7, the UWB localization timeslot and the UWB sensing timeslot are distinct and non-overlapping with respect to time. In the UWB localization timeslot, the system 100 operates in localization mode in which the set of system nodes 110 transmit messages to the target device 120 to localize the target device 120. As an example, the system 100 is configured to provide UWB localization periodically such that there is one or more intervening timeslots between two adjacent UWB localization timeslots. During this intervening timeslot, the system 100 is configured to provide a UWB sensing timeslot in which the system 100 operates in a sensing mode to at least provide in-vehicle sensing. The UWB sensing mode includes performing sensing functions with UWB CIR and UWB radar. The UWB CIR and the UWB radar may occur during the UWB sensing timeslot in a number of ways, as discussed below.

FIG. 7B illustrates a first example of the UW sensing timeslot according to an example embodiment. For example, the UWB sensing timeslot may include a UWB CIR timeframe (T_{CIR}) followed by a UWB radar timeframe (T_{RADAR}), or vice versa (i.e., a UWB radar timeframe followed by a UWB CIR timeframe). As a non-limiting example, with respect to a set of four system nodes 110, the UWB CIR timeframe (T_{CIR}) includes a first timeframe in which a first system node 110 transmits at least a first message and a subset of other system nodes 110 receive at least that first message, a second timeframe in which a second system node 110 transmits at least a second message and a subset of other system nodes 110 receives at least that second message, a third timeframe in which a third system node 110 transmits a third message and a subset of other system nodes 110 receives at least that third message, and a fourth timeframe in which a fourth system node 110 transmits a fourth message and a subset of other system nodes 110 receives that fourth message. In this non-limiting example concerning a set of four system nodes 110, after the fourth system node 110 transmits the fourth message, then this process of transmitting from the first system node 110, the second system node 110, the third system node 110, and the fourth system node 110 is repeated as many times as the timeslot allows. Also, as a non-limiting example, with respect to FIG. 2A, the UWB radar timeframe (T_{RADAR}) includes a first timeframe in which the second dual-mode system node 110B transmits a radar transmission signal and receives a radar reflection signal based on the radar transmission signal, a second timeframe in which the third dual-mode system node 110B transmits a radar transmission signal and receives a radar reflection signal, and so forth for each of the dual-mode system nodes 110B. Upon enabling each of the dual-mode system nodes 110B to transmit and receive radar, the system 100 is configured to repeat this process again for as many times as the timeslot allows.

FIG. 7C illustrates a first example of the UW sensing timeslot according to an example embodiment. More specifically, the UWB sensing timeslot includes a combined mode with a combination timeframe (T_{RADAR+CM}) in which UWB radar and UWB CIR are performed. In this regard, for instance, referring to FIG. 2A as an example, the UWB sensing timeslot includes (i) a first timeframe in which the second dual-mode system node 110B (at the second location) transmits a radar transmission signal and receives a radar reflection signal based on the radar transmission signal while CIR data is received by a subset of other nodes that calculate CIR, (ii) a second timeframe in which third dual-mode system node 110B (at the third location) transmits a radar transmission signal and receives a radar reflection signal based on the radar transmission signal while CIR data is received by a subset of other nodes that calculate CIR, and (iii) so forth for each of the dual-mode system nodes 110B within the set of system nodes 110. As shown in FIG. 7C, referring to FIG. 2A as an example, after each dual-mode system node 110B has performed during its allocated timeframe, this process can repeat again beginning with the the second dual-mode system node 110B (at the second location) during a subsequent timeframe followed by the third dual-mode system node 110B (at the third location) during a next subsequent timeframe.

FIG. 8A and FIG. 8B illustrate non-limiting examples of sets of system nodes with respect to the vehicle 10 according to an example embodiment. FIG. 8A and FIG. 8B illustrate examples with at least one communication system node 110A, at least one dual-mode system node 110B, and at least one high-frequency (HF) radar device 140. In addition, FIG. 8A and FIG. 8B include non-limiting conceptual representations of the sensing regions of the HF radar devices 140 in the form of shaded triangles, which are also used in FIG. 10A and FIG. 10B.

FIG. 8A and FIG. 8B show examples that further includes HF radar to provide a number of additional benefits. More specifically, for example, higher frequency/higher bandwidth radars have higher resolution over UWB (e.g., <10 GHz) radars. Also, since antenna size decreases with increasing frequencies, this allows for the utilization of a multi antenna array to provide several beams pointed in multiple directions simultaneously. Hence, as shown in FIG. 8A and FIG. 8B, a single HF radar device 140 is operable to sense occupancy in multiple target locations (e.g., a plurality of seats) concurrently. The higher cost of using such HF radars is compensated by a reduction in the number of radar devices that are needed to cover target areas.

Furthermore, HF radar devices 140 with sub-THz radars may be used, for instance, for condition monitoring in vehicles 10 such as spill detection and security applications. HF radar devices 140 with mmWave and sub-THz radars may be used, for instance, for gesture recognition. These HF radars have better resolution for breathing rate, heart rate, and heart rate variability, which can then be used to detect emotions better. The system 100 may be configured to use emotion sensing to control lighting in the vehicle, select a playlist for the occupants, predict a possible fight before its occurrence, sense emergency situations, etc. Further, the system 100 may be configured to utilize emotions and body profiles to generate biometric data for one or more passengers, which is then utilized for vehicle access control and personalized user experience (e.g., seat adjustment, steering wheel adjustment, default playlist/radio stations, preferred destination list, etc.).

FIG. 8A and FIG. 8B illustrate non-limiting examples of node arrangements with respect to the vehicle 10. The embodiments are not limited to these node arrangements, as there are a number of other node arrangements. FIG. 8A and FIG. 8B also provide examples of node arrangements in which UWB radar, UWB communications, and HF radar are combinable to provide sensing state data and/or sensing applications.

FIG. 8A illustrates a first arrangement that includes an HF radar device 140 at the first location, a UWB communication system node 110A at the second location, a UWB communication system node 110A at the third location, and a UWB communication system node 110A at the fourth location. FIG. 8B illustrates a second arrangement that includes an HF radar device 140 at the first location, a UWB communication system node 110A at the second location, a UWB communication system node 110A at the third location, and a dual-mode system node 110B at the fourth location. In this regard, the second node arrangement of FIG. 8B differs with respect to the first node arrangement of FIG. 8A in that the fourth location in FIG. 8B includes a dual-mode system node 110B whereas the fourth location in FIG. 8A includes UWB communication system node 110A.

Referring to FIG. 8A and FIG. 8B, the system 100 is configured to determine backseat occupancy via a single HF radar device 140, which is positioned at the first location (e.g., a center and rear region within a cabin of the vehicle 10) such that the HF radar device 140 covers the backseat. FIG. 8A further shows that the sensing range of the HF radar device 140 is greater than the sensing range of the dual-mode system node 110B. In this regard, the system 100 is configured to use a single HF radar device 140 to detect backseat occupancy in FIGS. 8A-8B compared to the two UWB dual-mode system nodes 110B that are used to determine the same backseat occupancy in FIGS. 2A-2B.

FIG. 9 is a timing diagram that illustrates how the system 100 controls and manages UWB localization, UWB sensing, and HF sensing within the same UWB infrastructure according to an example embodiment. More specifically, in the example shown in FIG. 9, the processing system 130 is operable to establish a schedule and allocate predetermined timeslots for UWB localization and UWB sensing, respectively. As an example, the system 100 is configured to operate in a UWB localization mode periodically such that there is one or more intervening timeslots between two adjacent UWB localization timeslots. During this intervening timeslot, the system 100 is configured to provide a UWB sensing timeslot.

As aforementioned, the UWB sensing mode provides sensing functions with UWB CIR and UWB dual mode. In this regard, the UWB sensing timeslot of FIG. 9 is similar or the same as the UWB sensing timeslot (T_{S}) of FIG. 7A in that the UWB sensing timeslot may include a UWB CIR timeframe (T_{CIR}), UWB radar timeframe (T_{RADAR}), a combination timeframe of UWB radar and UWB CIR (T_{RADAR+CIR}), or any number and combination thereof. Also, as shown in FIG. 9, the UWB sensing timeslot is provided as an intervening timeslot between two adjacent UWB localization timeslots (T_{L}). In addition, FIG. 9 further illustrates a HF radar sensing timeslot, which is also provided in the intervening timeslot. Since the HF radar sensing does not interfere with the UWB sensing, the system 100 is configured such that the intervening timeslot includes both the UWB sensing timeslot and the HF radar sensing timeslot. In this regard, both UWB sensing and HF radar sensing are configured to occur simultaneously since they operate at different frequency ranges. That is, this intervening timeslot is configured to provide UWB sensing and HF radar sensing at the same time such that the system 100 is configured to use the HF radar data together with the UWB sensing data to generate robust sensor fusion data, thereby providing more robust decisions based thereupon.

Additionally or alternatively, as shown in FIG. 9, since the HF radar sensing does not interfere with the UWB frequency ranges, the HF radar sensing is configured to be activated anytime such as during the first UWB localization timeslot and/or during the second UWB localization timeslot. However, when the HF radar sensing occurs during these UWB localization timeslots, then the system 100 is configured to provide HF radar sensor data or sensor fusion data that includes HF radar data but does not include UWB sensing data. For example, when the HF radar sensing is activated during the UWB localization timeslots, the system 100 is configured to generate sensor fusion data that includes HF radar data, camera data, audio data, or any number and combination thereof (without the UWB sensing data since this mode cannot occur simultaneously with the UWB localization). Furthermore, in the event multiple HF radar devices 140 are being employed (e.g., several 24/60 GHz or sub-THz radars), then the system 100 is configured to schedule each of them in a separate timeslot or a same timeslot within UWB sensing timeslot depending on whether they are operating in same channel or not.

FIG. 10A and FIG. 10B illustrate non-limiting examples of node arrangements with respect to the vehicle 10. The embodiments are not limited to these node arrangements, as there are other possible node arrangements. More specifically, FIG. 10A illustrates a first arrangement that includes an HF radar device 140 at the first location, a UWB communication system node 110A at the second location, a UWB communication system node 110A at the third location, a UWB communication system node 110A at the fourth location, a first microphone 150 in a front left side, a second microphone 150 at a front right side, a third microphone 150 at a rear left side, a fourth microphone 150 at a rear right side, and a camera 160 at a front side. FIG. 10B illustrates a second arrangement that includes an HF radar device 140 at the first location, a UWB communication system node 110A at the second location, a UWB communication system node 110A at the third location, a dual-mode system node 110B at the fourth location, a first microphone 150 in a front left side, a second microphone 150 at a front right side, a third microphone 150 at a rear left side, a fourth microphone 150 at a rear right side, and a camera 160 at a front side. In this regard, the second node arrangement of FIG. 10B differs with respect to the first node arrangement of FIG. 10A in that the fourth location in FIG. 10B includes a dual-mode system node 110B whereas the fourth location in FIG. 10A includes UWB communication system node 110A. That is, in FIG. 10B, the system 100 is further configured to determine at least a front seat (e.g., driverseat or front left seat) occupancy. FIG. 10A and FIG. 10B provide a robust sensing infrastructure via a sensor system that includes at least one UWB communication system node 110A, at least one dual-mode system node 110B, at least one HF radar node, at least one microphone 150, and at least one camera 160.

As discussed, FIG. 10A and FIG. 10B illustrate examples of node arrangements for multi-sensor RF fusion applications. Furthermore, regarding FIG. 10A and FIG. 10B, the system 100 is configured to activate all of the sensors or a subset of all of the sensors of the sensor system depending on a number of factors (e.g., application, scenario, use case, etc.). For instance, as a non-limiting example, the system 100 is configured to activate a subset of sensors of the sensor system when the vehicle 10 comes to a stop and then turned off.

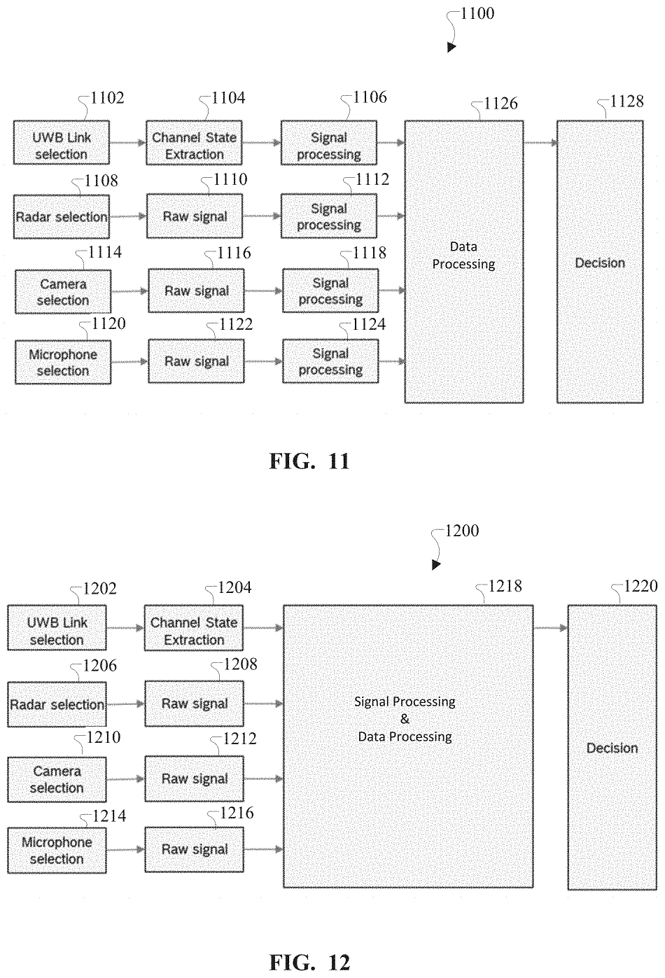

FIG. 11 illustrates a pipeline 1100 with several phases, which include a number of operations that are performed by the system 100 using the UWB infrastructure according to an example embodiment. The pipeline 1100 (FIG. 11) includes a number of phases that are the same as or similar to the phases of the pipeline 300 (FIG. 3). As descriptions of these similar or equivalent phases may be referenced with respect to FIG. 3, they are not repeated below. In this regard, for example, phase 1102 is similar to or the same as phase 302, phase 1104 is similar to or the same as phase 304, phase 1106 is similar to or the same as phase 306, phase 1108 is similar to or the same as phase 308, phase 1110 is similar to or the same as phase 310, and phase 1112 is similar to or the same as phase 312. However, in contrast to the pipeline 300 (FIG. 3), the pipeline 1100 (FIG. 11) further includes obtaining image data from one or more cameras 160 and/or obtaining audio data from one or more microphones 150. The pipeline 1100 includes further includes phase 1114, phase 1116, phase 1118, which relate to the obtainment of image data as discussed below. In addition, the pipeline 1100 further includes phase 1120, phase 1122, and phase 1124, which relate to the obtainment of audio data as discussed below. In this regard, as shown in FIG. 11, the pipeline 1100 is configured such that each sensing modality has its own pipeline. Also, for RF sensing to work, then at least one RF sensing modality should be available such as UWB CIR sensing or UWB/24 GHz/60 GHz/sub-THz radars along with camera and/or audio for sensor fusion.

At phase 1114, according to an example, the system 100 is operable to select one or more cameras 160 to capture image signals and/or video signals. The system 100 is configured to automatically select one or more cameras 160. The system 100 is configured to permit a manual selection of one or more cameras 160. Each camera 160 may be selected based on a number of factors (e.g., location of a camera 160, view of the camera 160, etc.). As non-limiting examples, for instance, one or more cameras 160 may be selected and used to detect a drowsy or distracted driver, an object left behind, a fighting/security scenario, an emergency situation, etc. Upon being selected, the camera 160 is triggered to capture image signals and/or video signals.

At phase 1116, according to an example, the system 100 is configured to capture and obtain the image signals and/or the video signals. More specifically, the system 100 is operable to obtain the image signals and/or the video signals in raw form. The system 100 is configured to provide the image signals and/or video signals to phase 1118 for signal processing.

At phase 1118, according to an example, the system 100 is configured to apply at least one image signal processing algorithm to the raw image signals and/or the raw video signals, which were captured at phase 1116. The system 100 is configured to perform this signal processing via a processor in that camera 160 itself, via the ECU, or via a combination thereof. During this phase, the system 100 is configured to improve a quality of the raw form of the image signals and/or video signals. In this regard, the system 100 is also configured to detect components of interest in image signals and/or video signals. For example, the image signal processing includes a denoising process, an image filtering process, an image enhancing process, an image editing process, or any number and combination thereof. After performing image signal processing on the raw image signals and/or video signals, the system 100 outputs and provides image data to phase 1126.

At phase 1120, according to an example, the system 100 is operable to select one or more microphones 150 to capture audio signals. The system 100 is configured to automatically select one or more microphones 150. The system 100 is configured to permit a manual selection of one or more microphones 150. Each microphone 150 may be selected based on a number of factors (e.g., location of a microphones 150, etc.). As non-limiting examples, for instance, one or more microphones may be selected and used to determine if at least one child or pet is left behind, as well other safety issues that may detected in audio data such as screaming, fighting, gun shots, etc. Upon being selected, the microphone 150 is triggered to capture audio signals.

At phase 1122, according to an example, the system 100 is configured to obtain the audio signals. More specifically, the system 100 is operable to obtain the audio signals in raw form. The system 100 is configured to provide the audio signals to phase 1124 for signal processing.

At phase 1124, according to an example, the system 100 is configured to apply at least one signal processing algorithm to the raw audio signals, which were captured at phase 1122. The system 100 is configured to perform this signal processing via a processor in that microphone or audio device itself, via the ECU, or via a combination thereof. During this phase, the system 100 is configured to perform signal processing to improve a quality of the raw form of the audio signals. For example, the signal processing includes a denoising process, a filtering process, any suitable audio processing, or any number and combination thereof. The system 100 is also configured to detect components of interest in the audio signals. After performing signal processing on the raw audio signals, the system 100 outputs and provides audio data to phase 1126.

Furthermore, phase 1126 and phase 1128 include the same or similar operations to phase 314 and phase 316, respectively, with respect to generating sensor fusion data and determining sensing state data, but further includes consideration of (i) image data and/or video data via one or more cameras 160 and (ii) audio data via one or more microphones 150 provided that the image data, the audio, or both are available at the given instance in which the sensor fusion data is generated for each selected sensing modality.

FIG. 12 illustrates a pipeline 500 with several phases, which include a number of operations that are performed by the system 100 using the UWB infrastructure according to an example embodiment. The pipeline 1200 (FIG. 12) includes a number of phases that are the same as or similar to the phases of the pipeline 1100 (FIG. 11). As descriptions of these similar phases may be referenced with respect to FIG. 11, they are not repeated below. In this regard, for example, phase 1202 is similar to or the same as phase 1102, phase 1204 is similar to or the same as phase 1104, phase 1206 is similar to or the same as phase 1108, phase 1208 is similar to or the same as phase 1110, phase 1210 is similar to or the same as phase 1114, phase 1212 is similar to or the same as phase 1116, phase 1214 is similar to or the same as phase 1120, and phase 1216 is similar to or the same as phase 1122. However, unlike the pipeline 1100 (FIG. 11), which processes raw forms of each of the communication signal, the radar reflection signal, the image/video signal, and the audio signal separately and then feeds each of these signals to phase 1126, the pipeline 1200 (FIG. 12) feeds raw forms of each of the communication signal, the radar reflection signal, the image/video signal, and the audio signal to phase 1218, which combines the signal processing operations and the data processing operations. More specifically, in the pipeline 1200, the ECU is operable to perform both the signal processing operations and the data processing operations at phase 1218, thereby offloading this signal processing burden from each selected node, camera 160, and microphone 150. In contrast, the pipeline 1100 has each selected system node 110, camera 160, and microphone 150 perform its own signal processing operations before proceeding to phase 1126. In addition, the phase 1220 includes the same or similar operations to the phase 1128.

As described in this disclosure, the embodiments provide a number of advantages and benefits. For example, the system 100 is advantageous in leveraging radar (e.g., UWB radar and/or HF radar) to provide various detections (e.g., breathing rate, heart rate, heart rate variability, or any number and combination thereof) to improve sensing state data in target areas of the predetermined sensing region. For example, the system 100 is operable to detect, for instance, a sleeping baby or a sleeping pet within the predetermined sensing region. With UWB radar and/or HF radar, the system 100 is operable to determine health statuses of drivers, passengers, or other animate objects. These detections and their corresponding sensing states contribute to improving the safety of each living being within the vehicle 10 and/or within a vicinity of the vehicle 10.

In addition, the system 100 includes an UWB infrastructure, which is configured to provide accurate ranging features and robustness to relay attacks. With UWB, the system 100 is operable to provide better time/spatial resolution than some other alternative wireless technologies. In addition, UWB sensing technologies provides more fine-grained sensing capabilities, especially for in-vehicle environments with strong multi-path efforts, compared with other wireless sensing technologies. Moreover, UWB communications is more energy efficient and experiences less interference compared to some other alternative wireless communications.

Advantageously, the system 100 is operable to provide sensing that covers the entire vehicle. For example, the system 100 is operable to detect a living being (e.g., child, pet, etc.) even when that living being is not in a seat, but in another spot, such as on a vehicle's floor, in an area between seats, in a vehicle's trunk, or any other place within a vehicle's interior space. The system 100 is operable address this issue by fusing radar data with UWB communication data, which is provided by an UWB infrastructure that includes UWB system nodes 110 associated with vehicle access control and keyless entry. At the same time, the system 100 is operable to fuse UWB communication data from UWB communicating devices together with image data from cameras 160 and audio data from audio sensors, thereby providing sensing state data that is able to account for objects left behind and two-way communications for emergencies, as well as a number of other useful features.

That is, the above description is intended to be illustrative, and not restrictive, and provided in the context of a particular application and its requirements. Those skilled in the art can appreciate from the foregoing description that the present invention may be implemented in a variety of forms, and that the various embodiments may be implemented alone or in combination. Therefore, while the embodiments of the present invention have been described in connection with particular examples thereof, the general principles defined herein may be applied to other embodiments and applications without departing from the spirit and scope of the described embodiments, and the true scope of the embodiments and/or methods of the present invention are not limited to the embodiments shown and described, since various modifications will become apparent to the skilled practitioner upon a study of the drawings, specification, and following claims. Additionally or alternatively, components and functionality may be separated or combined differently than in the manner of the various described embodiments, and may be described using different terminology. These and other variations, modifications, additions, and improvements may fall within the scope of the disclosure as defined in the claims that follow.

What is claimed is:

1. A method for managing communications among a set of system nodes configured to sense a predetermined region, the set of system nodes including at least a first system node and a second system node, the method comprising:
establishing, via a processor, a schedule that includes a communication timeslot and sensing timeslot that are non-overlapping;
transmitting a first message wirelessly from the first system node or the second system node during the communication timeslot;
transmitting a radar transmission signal from a second system node during the sensing timeslot;
receiving, via the second system node, a radar reflection signal during the sensing timeslot, the radar reflection signal being based on the radar transmission signal;
transmitting a second message wirelessly from the first system node or the second system node during the sensing timeslot;
determining channel state data of the second message via a subset of the set of system nodes during the sensing timeslot;
generating, via the processor, sensor fusion data based on the radar reflection signal and the channel state data; and
determining, via the processor, a sensing state of the predetermined region based on the sensor fusion data.

2. The method of claim 1, wherein:
the first system node transmits the first message in an ultra-wideband (UWB) range;
the second system node transmits the second message in the UWB range;
the second system node transmits the radar transmission signal in the UWB range; and
the second system node receives the radar reflection signal is received in the UWB range.

3. The method of claim 1, wherein the channel state data includes channel impulse response (CIR) data.

4. The method of claim 1, wherein the second system node is operable to switch between a radar mode and a communication mode such that the second system node transmits the radar transmission signal while operating in the radar mode and transmits the second message while operating in the communication mode.

5. The method of claim 1, further comprising:
transmitting a high-frequency (1f) radar transmission signal during the sensing timeslot; and
receiving a HF radar reflection signal during the sensing timeslot, the HF radar reflection signal being based on the HF radar transmission signal,
wherein the sensor fusion data is also generated based on the HF radar reflection signal.

6. The method of claim 1, further comprising:
capturing image data during the sensing timeslot,
wherein the sensor fusion data is also generated based on the image data.

7. The method of claim 1, further comprising:
capturing audio data during the sensing timeslot,
wherein the sensor fusion data is also generated based on the audio data.

8. The method of claim 8, further comprising:
generating, via a machine learning system, output data upon receiving the sensor fusion data as input,
wherein the sensing state is determined, via the processor, based on the output data.

9. The method of claim 1, wherein:
the predetermined region is an interior of a vehicle, and
the step of determining the sensing state further comprises determining a living being within the interior of the vehicle.

10. The method of claim 1, wherein the communication timeslot is a first localization timeslot in which the first message is transmitted to localize a target device.

11. The method of claim 1, wherein:
the predetermined region is adjacent to a vehicle, and
the step of determining the sensing state further comprises determining a living being within a vicinity of an exterior of the vehicle.

12. A method for managing communications among a set of system nodes configured to sense a predetermined region, the method comprising:
establishing, via a processor, a schedule that includes a first localization timeslot, a second localization timeslot, and a sensing timeslot, the sensing timeslot being between the first localization timeslot and the second localization timeslot;
transmitting a first set of messages wirelessly from a first system node or a second system node to a target device so that the target device is localized during the first localization timeslot;
transmitting a second set of messages wirelessly from the first system node to the target device so that the target device is localized during the second localization timeslot;
transmitting a radar transmission signal from the second system node during the sensing timeslot;
receiving, via the second system node, a radar reflection signal during the sensing timeslot, the radar reflection signal being based on the radar transmission signal;
transmitting another message wirelessly from the first system node or the second system node during the sensing timeslot;
determining channel state data of the another message via a subset of the set of system nodes during the sensing timeslot;
generating, via the processor, sensor fusion data based on the radar reflection signal and the channel state data; and
determining, via the processor, a sensing state of the predetermined region using the sensor fusion data.

13. The method of claim 12, wherein:
the first set of messages are transmitted in an ultra-wideband (UWB) range;
the second set of messages are transmitted in the UWB range;
the radar transmission signal is transmitted in the UWB range;
the radar reflection signal is received in the UWB range; and
the channel state data includes channel impulse response (CIR) data.

14. The method of claim 12, wherein:
the predetermined region is adjacent to a vehicle, and
the step of determining the sensing state further comprises determining a living being within a vicinity of an exterior of the vehicle.

15. The method of claim 12, further comprising:
generating, via a machine learning system, output data upon receiving the sensor fusion data as input,
wherein the sensing state is determined, via the processor, based on the output data.

16. The method of claim 12, further comprising:
capturing image data during the sensing timeslot,
wherein the sensor fusion data is also generated based on the image data.

17. The method of claim 12, further comprising:
capturing audio data during the sensing timeslot,
wherein the sensor fusion data is also generated based on the audio data.

18. The method of claim 12, further comprising:
transmitting a high-frequency (HF) radar transmission signal during the sensing timeslot; and
receiving a HF radar reflection signal during the sensing timeslot, the HF radar reflection signal being based on the HF radar transmission signal,
wherein the sensor fusion data is also generated based on the HF radar reflection signal.

19. The method of claim 12, wherein:
the predetermined region is an interior of a vehicle, and
the step of determining the sensing state further comprises determining a living being within the interior of the vehicle

20. The method of claim 12, wherein the second system node is operable to switch between a radar mode and a communication mode such that the second system node transmits the radar transmission signal while operating in the radar mode and transmits the second message while operating in the communication mode.
